(19) United States
(12) Patent Application Publication
(10) Pub. No.: US 2011/0148821 A1
(43) Pub. Date: Jun. 23, 2011

(54) Infrared Screen-Type Space Touch Apparatus

(75) Inventors: Yang Keun Ahn, Seoul (KR); Kwang Mo Jung, Gyeonggi-do (KR); Sung Hee Hong, Seoul (KR); Byoung Ha Park, Seoul (KR); Young Choong Park, Seoul (KR); Kwang Soon Choi, Gyeonggi-do (KR)

(73) Assignee: KOREA ELECTRONICS TECHNOLOGY INSTITUTE, Gyeonggi-do (KR)

(21) Appl. No.: 12/975,172

(22) Filed: Dec. 21, 2010

(30) Foreign Application Priority Data
Dec. 22, 2009 (KR) 10-2009-0128601

(51) Int. Cl. G06F 3/042

(52) U.S. Cl. 345/175

(57) ABSTRACT

Disclosed herein is an infrared screen-type space touch apparatus. The infrared screen-type space touch apparatus includes an infrared LED array provided with infrared LEDs arranged in a line, and configured to emit infrared rays and generate an infrared screen in a space. An infrared camera is installed to allow a lens thereof to face the infrared screen. A space touch sensor module senses a location touched by a user pointing means on the infrared screen from a gray scale image captured by the infrared camera.

Further, the infrared screen-type space touch apparatus may further include a pulse generation unit configured to periodically generate a pulse signal, and an LED driver unit coupled to the pulse generation unit and configured to supply pulsed DC power to the infrared LED array.

### PRIORITY

This patent application claims priority from patent application no. 10-2009-0128601, filed in the Republic of Korea on Dec. 22, 2009, and naming Yang Keun Ahn, Kwang Mo Jung, Sung Hee Hong, Byoung Ha Park, Young Choong Park, and Kwang Soon Choi as inventors, the disclosure of which is incorporated herein, in its entirety, by reference.

### TECHNICAL FIELD

The present invention relates, in general, to an infrared screen-type space touch apparatus, and, more particularly, to an infrared screen-type space touch apparatus, which includes infrared Light Emitting Diodes (LEDs) and an infrared camera, thus implementing a virtual touch screen in a free space.

### BACKGROUND ART

Recently, touch screens have been widely used in place of keyboards, and are configured to enable input to be directly made on a screen so that when a person's finger or an object touches a character or a specific location on the screen, the location of the touch can be sensed and then specific processing can be performed using installed software.

Such touch screens can display characters or picture information corresponding to functions in various manners, thus allowing users to easily perceive the functions. For this reason, touch screens have been applied to and variously used for devices for guidance, Point-Of-Sales (POS) terminals for stores, devices for typical business purposes, etc. in various places such as subway stations, department stores, and banks.

A conventional touch screen is configured such that a touch panel is attached to the screen of a monitor and, when a fingertip or an object touches a predetermined region, the generation of user input is sensed by sensing the variation in the characteristics of the region.

FIG. 1 is a diagram showing the construction of a conventional touch screen apparatus.

As shown in FIG. 1, the conventional touch screen apparatus is formed by attaching a touch panel to the screen of a typical monitor, and operates such that when a fingertip or an object touches a predetermined region, user input is sensed by sensing the variation in the characteristics of the predetermined region.

The entire conventional touch screen is divided into two-dimensional (2D) grids and analyzes the location of a touch, and is based on an interface scheme in which touches are sensed using capacitance, ultrasonic waves, infrared rays, a resistive film, sound wave recognition, or the like.

That is, since the conventional touch screen is configured in a 2D form in which a display screen and a touch panel are arranged on the same plane, it is impossible to implement a virtual touch screen scheme which enables a free space away from a display to be touched.

### SUMMARY OF THE EMBODIMENTS

Accordingly, the present invention has been made keeping in mind the above problems occurring in the prior art, and an object of the present invention is to provide an infrared screen-type space touch apparatus, which can sense the location of a touch made by a user in a free space away from a display device and which can process the command of the user based on the sensed touch location.

In order to accomplish the above object, the present invention provides an infrared screen-type space touch apparatus, including an infrared Light Emitting Diode (LED) array provided with infrared LEDs arranged in a line, and configured to emit infrared rays and generate an infrared screen in a space; an infrared camera installed to allow a lens thereof to face the infrared screen; and a space touch sensor module configured to sense a location touched by a user pointing means on the infrared screen from a gray scale image captured by the infrared camera.

Preferably, in order to reduce errors in sensing of touches, which may be caused by external light, the infrared screen-type space touch apparatus according to the present invention may further include a pulse generation unit configured to periodically generate a pulse signal, and an LED driver unit configured to supply Direct Current (DC) power to the infrared LED array when the pulse signal is input from the pulse generation unit, and to interrupt supply of the DC power to the infrared LED array when the pulse signal is not input from the pulse generation unit.

Preferably, the infrared camera may perform capturing when the pulse signal is input from the pulse generation unit.

Preferably, the infrared camera may be installed at a location which is closer to a monitor than to the infrared LED array.

Preferably, an infrared beam angle of the infrared LED array may be 10° or less.

Preferably, the space touch sensor module may include a binarization unit for binarizing the gray scale image captured by the infrared camera; a smoothing unit for smoothing the binary image generated by the binarization unit; a labeling unit for labeling the binary image smoothed by the smoothing unit; and a coordinate calculation unit for calculating center coordinates of a blob, a size of which is equal to or greater than a preset threshold, among blobs labeled by the labeling unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of a conventional touch screen apparatus;

FIGS. 2 and 3 are block diagrams showing an infrared screen-type space touch apparatus according to an embodiment of the present invention;

FIG. 4 is a diagram illustrating the principle based on which infrared screen-type space touch is sensed according to the present invention; and

FIG. 5 is a flowchart showing a space touch sensing method performed by the infrared screen-type space touch apparatus according to an embodiment of the present invention.

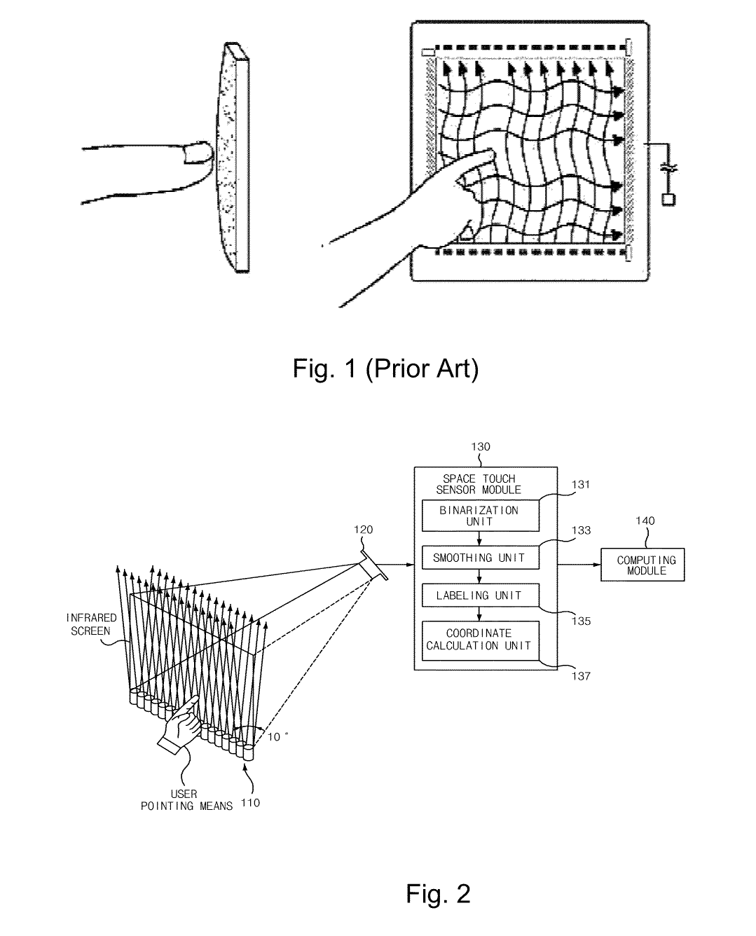

### DETAILED DESCRIPTION OF SPECIFIC EMBODIMENTS

Hereinafter, embodiments of an infrared screen-type space touch apparatus according to the present invention will be described in detail with reference to the attached drawings.

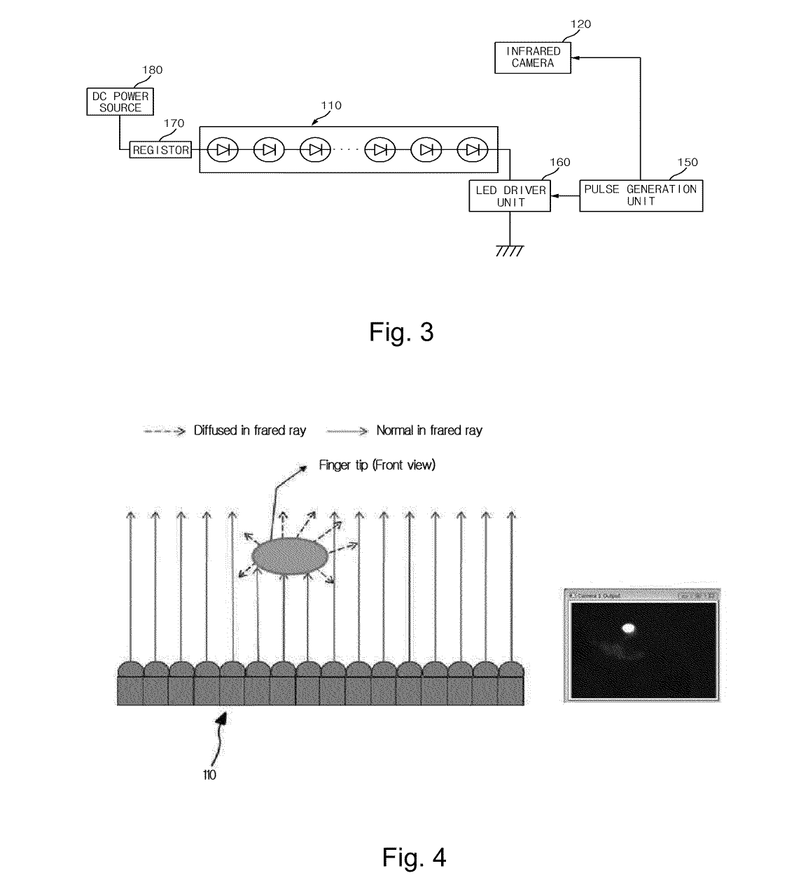

FIGS. 2 and 3 are block diagrams showing an infrared screen-type space touch apparatus according to an embodiment of the present invention.

As shown in FIG. 2, an infrared screen-type space touch apparatus according to an embodiment of the present invention includes an infrared Light Emitting Diode (LED) array 110 configured to emit infrared rays and generate an infrared screen in a space, an infrared camera 120 installed to allow the lens thereof to face the infrared screen, and a space touch sensor module 130 configured to sense a location which is touched by a user pointing means such as a fingertip or a touch pen on the infrared screen from a gray scale image captured by the infrared camera 120.

The construction of the present invention will be described in more detail. First, the infrared screen is a virtual touch screen which is formed in a space and is generated by the infrared LED array 110.

The lateral length of the infrared screen is determined by the number of infrared LEDs arranged in a line.

A rectangular frame may be formed on the edge of the infrared screen to allow the user to easily perceive the contour of the infrared screen. In that case, the infrared LED array 110 may be installed in any one of upper, lower, left and right portions of the frame.

The infrared LED array 110 is preferably implemented using narrow-angle infrared LEDs. In other words, it is preferable that the infrared beam angle of the infrared LED array 110 be 10° or less. Since such infrared LEDs are semiconductor elements which are widely used in the field of the art to which the present invention pertains, a detailed description thereof is omitted here.

As is well known to those skilled in the art, the infrared camera 120 includes therein a filter for cutting off the visible band and allowing only the infrared band to pass therethrough, and is configured to cut off visible rays generated by indoor fluorescent lamps or the like and capture only infrared rays in the form of a gray scale image.

Furthermore, the infrared camera 120 is installed in front of the user and may be installed, for example, on the top of a Liquid Crystal Display (LCD) monitor.

As shown in FIG. 3, the infrared screen-type space touch apparatus according to the embodiment of the present invention may further include a pulse generation unit 150 for periodically generating a pulse signal, an LED driver unit 160 for driving the infrared LED array 110 in synchronization with an input pulse periodically input from the pulse generation unit 150, and a resistor 170 disposed between a Direct Current (DC) power source 180 and the infrared LED array 110.

In the above-described construction, the pulse generation unit 150 generates a pulse signal having, for example, a width of 100 μs per 10 ms.

In greater detail, the LED driver unit 160 supplies DC power to the infrared LED array 110 when a pulse signal is input from the pulse generation unit 150, and interrupts the supply of DC power to the infrared LED array 110 when a pulse signal is not input from the pulse generation unit 150.

That is, the LED driver unit 160 drives the infrared LED array 110 in response to the pulse signal without always turning on the infrared LED array 110. The reason for requiring pulse driving rather than constant current driving is as follows.

An LED is typically operated using a constant current driving method or a pulse driving method, and is brighter when being operated using the pulse driving method. That is, the pulse driving method allows higher current to flow into the LED than does the constant current driving method, and thus can produce brighter light. However, since the LED may be damaged by the pulse driving method, adjusting the time, that is, adjusting the pulse width, is required.

For example, when an LED is driven using a pulse, a current of 1 A can flow through the LED. In contrast, when the LED is driven using a constant current, a current of 100 mA can flow into the LED. When the LED is operated using the pulse driving method rather than the constant current driving method in this way, brightness ten times that obtained by the constant current driving method can be obtained, and thus errors in the sensing of touches, which may be cased by external light (for example, sunlight, the light of a fluorescent lamp, or the light of an incandescent lamp), can be reduced.

Meanwhile, the infrared camera 120 captures an image when a pulse signal is input from the pulse generation unit 150 as a photo is taken when a camera flash is turned on.

FIG. 4 is a diagram showing the principle based on which an infrared screen-type space touch is sensed according to the present invention.

The image captured by the infrared camera 120 is black because of infrared rays emitted from the infrared LED array 110 before the user pointing means enters the infrared screen.

However, when the user pointing means enters the infrared screen, the infrared rays become scattered (or diffused) on the infrared screen, and a portion in which the user pointing means is located is seen to be bright, as shown in FIG. 4. Consequently, when a center point is found by performing image processing on this bright portion, the X and Y coordinates of the location of space touch made on the infrared screen can be sensed.

The space touch sensor module 130 may include a binarization unit 131, a smoothing unit 133, a labeling unit 135, and a coordinate calculation unit 137.

The binarization unit 131 binarizes a gray scale image captured by the infrared camera 120. In detail, the binarization unit 131 performs binarization by adjusting pixel values less than a preset threshold to ‘0 (black)’ and by changing pixel values greater than the threshold to ‘255 (white)’ with respect to individual pixels on the gray scale image captured by the infrared camera 120.

The smoothing unit 133 smoothes the binary image generated by the binarization unit 131, and thus removes noise from the binary image.

The labeling unit 135 labels the binary image smoothed by the smoothing unit 133. In detail, the labeling unit 135 labels the pixels, the values of which have been adjusted to 255. For example, the labeling unit 135 assigns different numbers to white regions (blobs) using an 8-neighbor pixel labeling technique, thus reconstructing the binary image. As described above, the labeling operation is a technique widely used in image processing fields, and thus a detailed description thereof will be omitted.

The coordinate calculation unit 137 calculates the center coordinates of a blob having a size equal to or greater than a preset threshold among the blobs labeled by the labeling unit 135. In detail, the coordinate calculation unit 137 regards the blob, the size of which is equal to or greater than the threshold, as a finger or an object which touched the infrared screen, and then calculates the center coordinates of the blob. In this case, the center coordinates may be detected using various detection methods. For example, the coordinate calculation unit 137 sets middle values of the minimum X and Y values and the maximum X and Y values of the relevant blob as the center of gravity, and determines those middle values to be the coordinates of the touch.

Further, when a plurality of blobs, the sizes of which are equal to or greater than the threshold, are present, the coordinate calculation unit 137 may calculate the center coordinates of only the largest blob.

Meanwhile, the infrared screen-type space touch apparatus according to the present invention may further include a computing module 140 for performing a function corresponding to the location information sensed by the space touch sensor module 130.

In detail, when the space touch sensor module 130 outputs the location information, the computing module 140 may perceive the location information to be the selection of a function and may perform a relevant function, for example, the function of switching a screen displayed on a display device.

Further, the computing module 140 is connected to external devices over a wired or wireless network. In that case, the external devices can be controlled using the location information sensed by the space touch sensor module 130. In other words, when the location information corresponds to a control command for a relevant external device, the relevant external device performs the function corresponding to the control command. In this case, external devices may include home network-based electric home appliances and a server which are connected over a network.

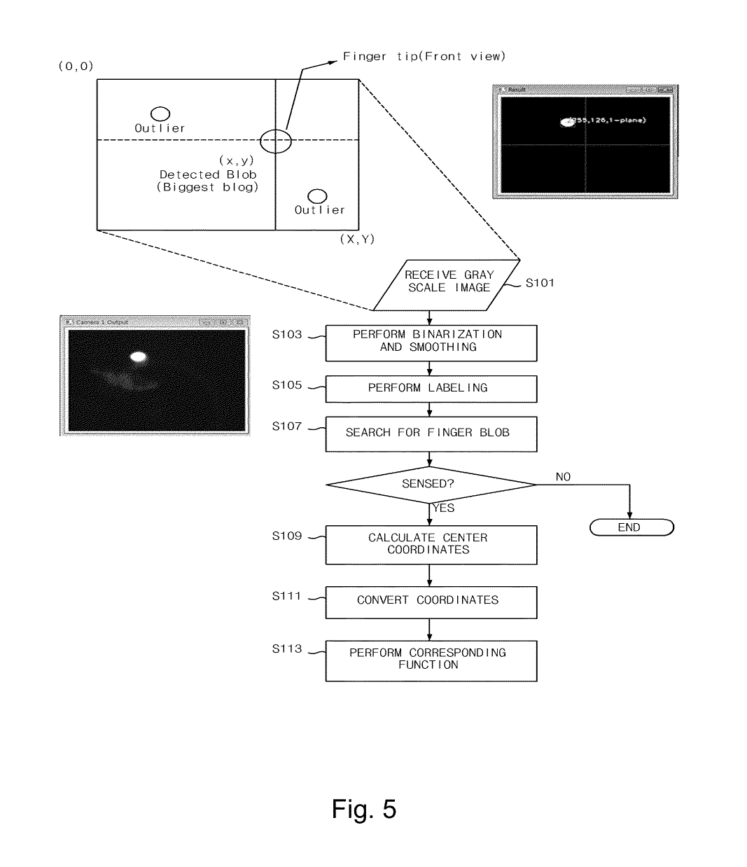

FIG. 5 is a flowchart showing a space touch sensing method using the infrared screen-type space touch apparatus according to an embodiment of the present invention.

First, the space touch sensor module 130 receives the gray scale image captured by the infrared camera 120 from the infrared camera 120 at step S101, and binarizes and smoothes the gray scale image at step S103. Next, a resulting binary image is labeled at step S105, and a blob corresponding to the user pointing means (finger) is searched for in labeled blobs at step S107.

As a result of the search, when the blob corresponding to the user pointing means is found, the center coordinates of the blob are calculated at step S109. The calculated center coordinates are converted into the center coordinates of the infrared screen and are transferred to the computing module 140 at step S111.

Then, the computing module 140 performs the function corresponding to the location information sensed by the space touch sensor module 130 at step S113.

The infrared screen-type space touch apparatus according to the present invention is not limited to the above-embodiments and can be variously modified and implemented without departing from the scope and spirit of the invention.

As described above, the infrared screen-type space touch apparatus according to the present invention is advantageous in that it can provide users with a more realistic, interactive user interface and can offer them pleasure and convenience. Therefore, kiosks to which the present invention is applied will be implemented using such a realistic user interface in the near future.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An infrared screen-type space touch apparatus, comprising:
an infrared Light Emitting Diode (LED) array provided with infrared LEDs arranged in a line, and configured to emit infrared rays and generate an infrared screen in a space;
an infrared camera installed in a position to allow a lens thereof to face the infrared screen;
a pulse generation unit configured to periodically generate a pulse signal;
an LED driver unit, coupled to the pulse generation unit, and configured to supply pulsed Direct Current (DC) power to the infrared LED array when the pulse signal is input from the pulse generation unit, and to interrupt supply of the DC power to the infrared LED array when the pulse signal is not input from the pulse generation unit; and
a space touch sensor module, coupled to the infrared camera, and configured to sense a location touched by a user pointing means on the infrared screen from a gray scale image captured by the infrared camera.

2. The infrared screen-type space touch apparatus according to claim 1, wherein the infrared camera is coupled to the pulse generation unit and performs capturing when the pulse signal is input from the pulse generation unit.

3. The infrared screen-type space touch apparatus according to claim 2, wherein the infrared camera is installed at a location which is closer to a monitor than to the infrared LED array.
